(19) United States
(12) Patent Application Publication
(10) Pub. No.: US 2012/0117022 A1
(43) Pub. Date: May 10, 2012

(54) METHOD AND SYSTEM FOR VERIFYING DATA ACCURACY

(76) Inventors: Jean-Michel Collomb, Grasse (FR); Vineetha Vasudevan, Karnataka (IN); Madan Gopal Devadoss, Karnataka (IN)

(21) Appl. No.: 13/384,136

(22) PCT Filed: Jun. 15, 2010
(86) PCT No.: PCT/IN2010/000405

§ 371 Date: Jan. 13, 2012

(30) Foreign Application Priority Data
Jul. 13, 2009 (IN) 1654/CHE/2009

(51) Int. Cl. G06F 17/30

(52) U.S. Cl. 707/602; 707/E17.005

(57) ABSTRACT

Presented is a method and system for verifying data accuracy. The method includes defining various steps of a data flow process, specifying data structure details at each step of the data flow process by metadata, providing at least one column dedicated for auditing in every table of a data warehouse involved in the data flow process, logging details related to a task execution at each step of the data flow process in the at least one column dedicated for auditing, storing the details related to a task execution along with data structure details and providing a visual representation of the stored details.

### BACKGROUND

It is not uncommon to find organizations struggling to manage and align their IT operations with business processes these days. The situation has become more pronounced for large scale corporations that are spread across multiple geographies. Considering that timely and accurate business information can play a critical role in an organization's success or failure, managements across the board are waking up to meet this key challenge. Business intelligence (BI) can play an important part in this regard.

Generally speaking, business intelligence basically includes applications and technologies that are used to help a business acquire a better understanding of its business context and supports superior decision-making. Many IT vendors, such as Hewlett-Packard, offer BI applications in the market place these days. There are BI tools that are available in open source platform as well. These applications are routinely used for gathering, storing, analyzing, and reporting data, in order to help enterprise users make informed business decisions.

One of the most popular methods to review the data analyzed by a BI tool is to formulate a report. Another method is to generate a dashboard. Organizations are increasingly employing such data presentation tools in evaluating business critical information. Thus, these reports play a key role during a business decision making. In this context, considering their potential importance, it is important to realize that business users need to trust the information provided to them in the form of such reports. Therefore, quality and accuracy of the data coming from a BI application or a data warehouse assumes a lot of significance. To date, this is primarily possible only through manual intervention. Further, verifying the accuracy of the data presented in a report or a dashboard generally implies backtracking each step of the data movement and verifying for each of them, the validity of the data in the tables and the success of each data processing job that has been executed. This activity is time consuming and expects the user to have detailed knowledge of the data flow in a data warehouse.

### BRIEF DESCRIPTION OF THE DRAWINGS

For a better understanding of the invention, embodiments will now be described, purely by way of example, with reference to the accompanying drawings, in which:

FIG. 1 shows a graphic representation of a top level architecture view of a computer application according to an embodiment.

FIG. 2 shows a graphic representation of an exemplary metadata driven data flow in a computer application according to an embodiment.

FIG. 3 shows status calculation for a row in a data warehouse table according to an embodiment.

FIG. 4 shows generation of data accuracy or backtracking reports through a backtracking data mart according to an embodiment.

FIG. 5 shows a flow chart of a method for verifying accuracy of data generated from a computer application according to an embodiment.

FIG. 6 shows a block diagram of a system for verifying data accuracy according to an embodiment.

### DETAILED DESCRIPTION OF THE INVENTION

Proposed is a solution for verifying accuracy of data generated from a computer application. The method describes how the accuracy of data originating from a computer application can be automatically verified to increase the reliability of data presentation means, such as, reports and dashboards.

The term backtracking, in the context of present invention, refers to the ability to determine the reasons behind a particular result. For example, for a process, a user may wish to determine what caused a result to be generated. With backtracking, a user can come to know what caused a result to be generated, and in case of an anomaly how to rectify the problem to correct an improper result.

The term computer application, in the context of present invention, includes tools, such as, but not limited to, a data warehouse application, business intelligence tools, tools to extract, transform, and load data into a repository, and tools to manage and retrieve metadata.

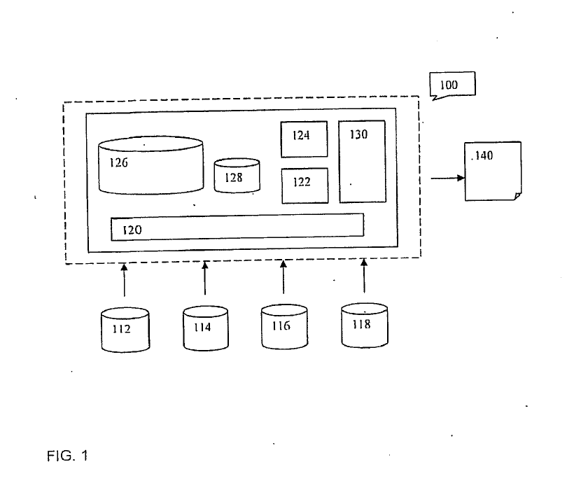

FIG. 1 shows a graphic representation of a top level architecture view of an exemplary computer application 100 according to an embodiment. The computer application 100 may be a business intelligence application, a data warehouse or any computer application having metadata driven data flow.

In the present embodiment, a top level architecture view in case of business intelligence (BI) application is described.

For the sake of clarity, business intelligence usually refers to the information that is available for the enterprise to make decisions on. Or, in other words, it refers to tools and process that provide the business leaders the means to extract meaningful information about their business. One vehicle to deliver business intelligence is data warehousing. A data warehousing system is a subcomponent of and a vehicle for delivering business intelligence. It is the foundation that business intelligence is built upon.

Referring to FIG. 1, the computer application 100 includes a data collection layer 120, a data aggregation layer 122, a business view layer 124, a data warehouse 126, a data mart 128 and a metadata repository 130.

The data collection layer 120 is responsible for data collection, data loading and reconciliation. Although, a single data layer 120 has been depicted for carrying out the aforementioned tasks, it is possible that these tasks may be carried out by separate components of a computer application in other embodiments.

The data collection layer 250 collects data from a single or multiple data sources 112, 114, 116 and 118. The kind and complexity of data sources may vary depending on the nature of computer application and processes involved. For example, computer systems, network elements, computer databases and other applications may act as data sources.

The data aggregation layer 122 is responsible for the aggregation of data. The data business view layer 124 is responsible for generation of a business view.

The complete data flow process, from data collection to business view of the data, is specified by metadata stored in the metadata repository 130.

The collected and reconciled data is moved into the data warehouse 126 where it is summarized and archived for reporting purposes.

The data mart 130 is used to store runtime and static information related to a task execution in the computer application 100. The data mart 130 and data warehouse 126 are used to generate reports verifying accuracy of data processed through computer application 100.

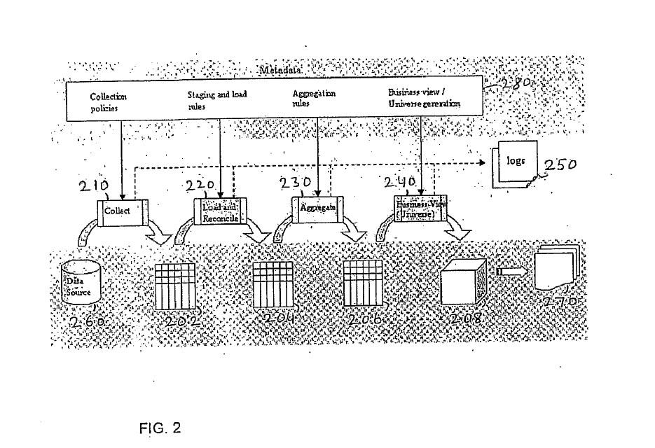

FIG. 2 shows a graphic representation of an exemplary metadata driven data flow in an exemplary computer application according to an embodiment.

In the present embodiment, metadata driven data flow in a business intelligence (BI) application is described.

Referring to FIG. 2, steps 210, 220, 230 and 240 describe the data flow process in a business intelligence application. The complete data flow process, from data collection to business view of the data, is specified by consistent metadata stored in a repository 280. Metadata is “data about other data”. It is often used to control the handling of data and can be obtained through a manual process of keying in or through automated processes. It describes each step of data processing as well as structure of data input and output. Metadata ensures that the data has the right format and relevancy. In the present embodiment, metadata is managed through a repository 280 that combines information from multiple sources. The repository 280 specifies the collection policies, the staging and loading rules, the aggregation rules and the business view layer.

Step 210 includes collecting data from a data source 260. For the sake of simplicity, only a single data source has been illustrated. However, people skilled in the art would appreciate that there may be multiple sources of data. Further, as mentioned earlier, the kind and complexity of data sources may also vary depending on the nature of computer application and processes involved. The collection policies in the repository 280 define the metrics that needs to be collected from a data source, such as data source 260.

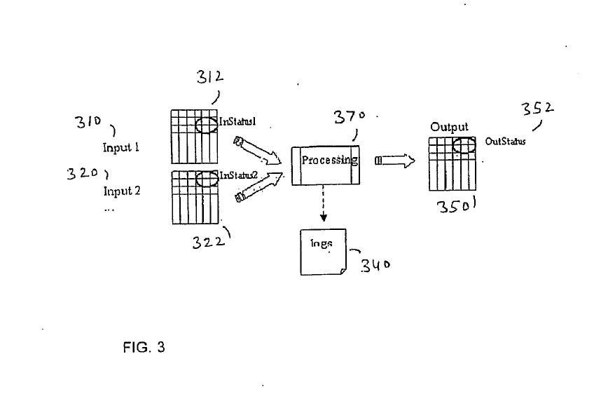

Referring again to FIG. 2, it is to be noted that each task in the data flow process is uniquely identified. Upon execution of a task at a particular step of the data flow process, a set of activities take place. One, a set of auditing messages (such as, from a message dictionary) and metrics, such as, performance, volume metrics and execution status, are logged 250. Two, the validity and trust statuses related to the task execution are calculated and recorded in every table of a data warehouse involved in the data flow process. This process is described in more detail later with reference to FIG. 3. For the moment, it should be appreciated that the validity and trust statuses related to a task execution are calculated and propagated at each step of the data flow process. This is illustrated by tables 202, 204, and 206.

Step 220 includes loading and reconciliation of data. The staging and loading policies in metadata 280 define the loading and reconciliation mechanism in the computer application. The reconciliation policies address the reconciliation of data to the source data sources. It includes matching the data entered against the source data to provide an accurate and valid value.

Step 230 includes aggregation of data. The aggregation policies in metadata 280 define the rules of aggregation and summarization of the data for long term storage and analytics.

Step 240 provides the end user view of the data. Business View may be used to generate reports 270. In Business View, universe can be created by connecting more than one database at a time and generate reports.

FIG. 3 shows status calculation for a row in a data warehouse table according to an embodiment.

As mentioned above, each step (data collection, data loading & reconciliation, data aggregation and business view) in the above described data flow process is responsible for calculation and propagation of validity and trust statuses related to a task execution.

The output statuses for a row are calculated based on the input statuses of all input rows involved in the calculation of the output row and the actual status of the processing itself. Referring to FIG. 3, the output statuses for a row 350 in output table 352 are calculated based on the input statuses of input rows (310 and 320) in input tables (312 and 322) involved in the calculation of the output row 350 and the actual status of the processing (370) itself.

Information related to a task execution is logged consistently in data processing logs 340. Any message related to an abnormal processing of a row appears in the logs with the information necessary to identify the row itself.

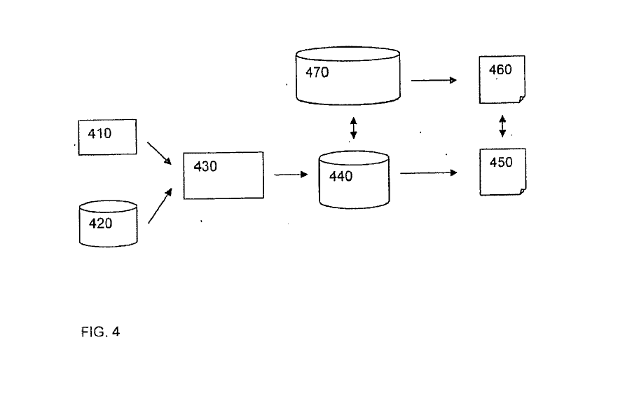

FIG. 4 shows generation of data accuracy or backtracking reports through a backtracking data mart according to an embodiment.

In an embodiment, the computer application 100 uses a data accuracy or backtracking module 430 to populate a data mart (“backtracking data mart”) 440. A data mart is a subset of an organizational data store, usually oriented to a specific purpose data subject. Data marts are designed to focus on specific business functions within an organization. In the present embodiment, the data mart 440 is used to store the history of runtime and static information pertaining to execution of jobs/tasks. The runtime information is related to various task executions and obtained from data processing logs 420. The static information is related to task details and obtained from metadata 410.

The data mart 440 correlates data with the data warehouse 470. It contains the history of each task execution with the associated metrics attached to the description of the dataflow (metadata). Both data warehouse 470 and data mart 450 may be used to create reports and/or dash boards for a user, providing details, such as, but not limited to, statistics on task execution metrics (volume and performance information), history of task errors, number of rejected records, and backtracking of a specific measure (row).

### Reporting

A successful reporting format in a business intelligence environment requires a good deal of attention. Unless it is certain that the data has been validated, it is useless from a business end user's perspective. Therefore, it is important that the end user has the option to verify the data provided in a report or dashboard. The present invention provides this option to an end user.

Since each row in the data warehouse tables contains validity and trust statuses as well as references to task ID and details, end user reports include validity and trust status for all the information displayed in a report. A user merely needs to glance at a report to know whether a task has been executed successfully. Further, the appearance of ‘data validity’ information in a report can be fine tuned depending on the report type (on demand, generated in batch etc). To illustrate, a data validity indicator may be displayed as a ‘tool tip’ when the end-user moves the mouse over the measures represented in the reports, invalid data may be displayed as ‘strike though’ in the end-user report, a data validity summary for the whole report may be displayed in the end-user report, a ‘validity status report’ may be associated to an end-user report and a ‘debug’ version of the end-user report may include data validity information with links to backtracking reports.

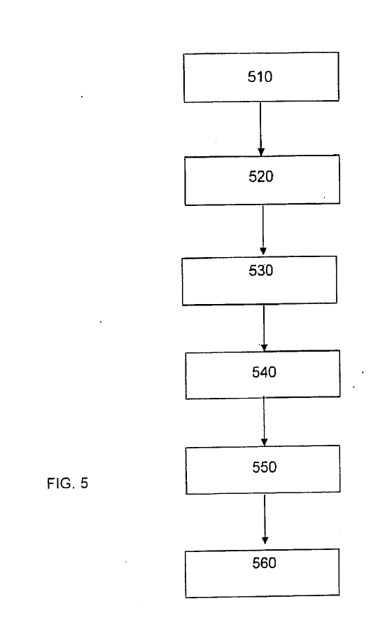

FIG. 5 shows a flow chart of a method for verifying accuracy of data generated from a computer application according to an embodiment. The method may be implemented on a computer system, such as, but not limited to, a desk top computer, a computer server and a note book computer.

Step 510 includes defining various steps of a data flow process. A data may travel through a number of processing steps before it reaches a user. This is illustrated in FIG. 2, in the context of a business intelligence application. In that example, as described earlier, the data is collected from a data source and processed through a number of steps (such as, loading and reconciliation, aggregation, etc.) before it reaches a business user. The data flow includes the whole process, from data collection to the reporting of data.

Step 520 includes specifying data structure details at each step of the data flow process by metadata. Again, as illustrated in FIG. 2, metadata describes each step of the data processing as well as structure of data input and output. The collection policies, the staging and loading rules, the aggregation rules, etc. all form part of the metadata.

Step 530 includes providing at least one column dedicated for auditing in every table of a data warehouse involved in the data flow process. Each table in the data warehouse operably linked to the computer application contains a plurality of columns dedicated for auditing. For example, the data warehouse may contain a set of columns providing: (a) a task ID (for identifying a process instance) and (b) validity and trust status for all the information in a row that has been created by a task.

Step 540 includes logging details related to a task execution at each step of the data flow process in the at least one column dedicated for auditing. Various details related to a task execution, such as, providing a unique identification to each task, logging auditing messages and metrics information related to each task execution and logging messages related to abnormal processing of a row with information necessary to identify the row itself, are logged in at least one column dedicated for auditing.

Step 550 includes storing the details related to a task execution along with data structure details. The details related to a task exaction are obtained from the data flow logs and data structure details are obtained from the metadata. The aforesaid details may be stored in an audit data mart schema.

Step 560 includes providing a visual representation of the stored details. The visual representation of the stored details may be provided in the form of reports or dashboards.

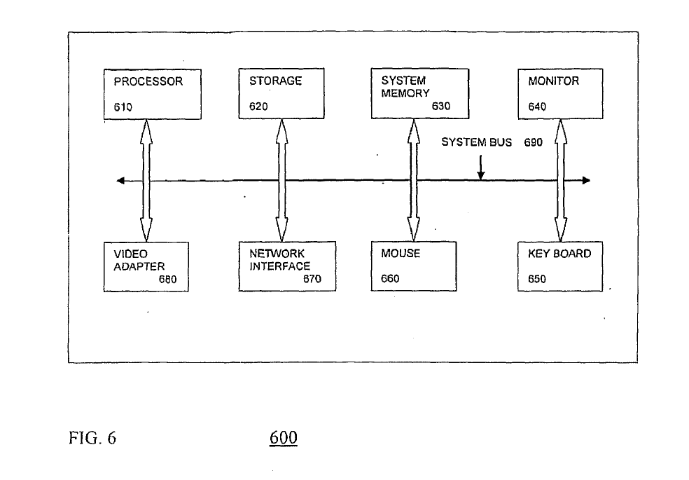

FIG. 6 shows a block diagram of a computer system 600 upon which an embodiment may be implemented. The computer system 500 includes a processor 610, storage medium 620, a system memory 630, a monitor 640, a keyboard 650, a mouse 660, a network interface 670 and a video adapter 680. These components are coupled together through a system bus 690.

The storage medium 620 (such as a hard disk) stores a number of programs including an operating system, application programs and other program modules. A user may enter commands and information into the computer system 600 through input devices, such as a keyboard 650, a touch pad (not shown) and a mouse 660. The monitor 640 is used to display textual and graphical information.

An operating system runs on processor 610 and is used to coordinate and provide control of various components within personal computer system 600 in FIG. 6. A business intelligence application, such as, but not limited to, BSM Reporter Data warehouse from Hewlett-Packard, may be used on the computer system 600 to perform the method steps of FIG. 5 and the various embodiments described above.

It would be appreciated that the hardware components depicted in FIG. 6 are for the purpose of illustration only and the actual components may vary depending on the computing device deployed for implementation of the present invention. Further, the computer system 600 may be, for example, a desktop computer, a server computer, a laptop computer, or a wireless device such as a mobile phone, a personal digital assistant (PDA), a hand-held computer, etc.

It will be appreciated that the embodiments within the scope of the present invention may be implemented in the form of a computer program product including computer-executable instructions, such as program code, which may be run on any suitable computing environment in conjunction with a suitable operating system, such as, Microsoft Windows, Linux or UNIX operating system. Embodiments within the scope of the present invention may also include program products comprising computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer.

It should be noted that the above-described embodiment of the present invention is for the purpose of illustration only. Although the invention has been described in conjunction with a specific embodiment thereof, those skilled in the art will appreciate that numerous modifications are possible without materially departing from the teachings and advantages of the subject matter described herein. Other substitutions, modifications and changes may be made without departing from the spirit of the present invention.

1. A computer-implemented method for verifying data accuracy, the method comprising:
defining various steps of a data flow process;
specifying data structure details at each step of the data flow process by metadata;
providing at least one column dedicated for auditing in every table of a data warehouse involved in the data flow process;
logging details related to a task execution at each step of the data flow process in the at least one column dedicated for auditing;
storing the details related to a task execution; and
providing a visual representation of the stored details.

2. A method according to claim 1, wherein the visual representation is provided in form of reports and/or dashboards.

3. A method according to claim 1, wherein the visual representation includes statistics on task execution metrics, history of task errors, number of rejected records and backtracking of a specific measure.

4. A method according to claim 1, wherein the data flow includes data collection to reporting of the data.

5. A method according to claim 1, wherein specifying data structure details include describing each step of data processing, and structure of data input and output.

6. A method according to claim 1, wherein logging details include providing a unique identification to each task, logging auditing messages and metrics information related to each task execution, and
logging messages related to abnormal processing of a row with information necessary to identify the row itself.

7. A method according to claim 1, wherein the details related to a task execution are stored in an audit data mart schema.

8. A method according to claim 1, wherein the at least one column dedicated for auditing includes details related to identifying a process instance.

9. A method according to claim 1, wherein the at least one column dedicated for auditing includes details related to validity and trust status for information in a row that has been created by the task.

10. A method according to claim 1, wherein each step in the data flow involves calculating and propagating validity and trust statuses.

11. A method according to claim 1, wherein the data flow process occurs in a business intelligence application.

12. A system for verifying data accuracy, the system comprising:
means for defining various steps of a data flow process;
means for specifying data structure details at each step of the data flow process by metadata;
means for providing at least one column dedicated for auditing every table of a data warehouse involved in the data flow process;
means for logging details related to a task execution at each step of the data flow process in the at least one column dedicated for auditing;
means for storing the details related to a task execution along with data structure details obtained from the metadata; and
means for providing a visual representation of the stored details.

13. A computer program comprising computer program means adapted to perform all of the steps of claim 1 when said program is run on a computer.

14. A computer program according to claim 13 embodied on a computer readable medium.
